(19) United States
(12) Patent Application Publication
(10) Pub. No.: US 2006/0037409 A1
(43) Pub. Date: Feb. 23, 2006

(54) Rotary type component force measuring device

(75) Inventor: Tatsuo Ichige, Kitamoto-City (JP)

Correspondence Address: ERIC ROBINSON, PMB 955, 21010 SOUTHBANK ST., POTOMAC FALLS, VA, 20165, US

(73) Assignee: A&D COMPANY, LIMITED, Toshima-ku (JP)

(21) Appl. No.: 11/092,750

(22) Filed: Mar. 30, 2005

(30) Foreign Application Priority Data
Aug. 23, 2004 (JP) 2004-241923

(51) Int. Cl. G01L 1/22

(52) U.S. Cl. 73/862

(57) ABSTRACT

A rotary type component force measuring device capable of finding a highly accurate component force is provided. This measuring device has a rotary type component force detector comprising in integrated manner, a rim mounting frame, a hub mounting frame, a second sensing beam of a character I shaped sectional type which couples and the mounting frames, and a first sensing beam which couples the second sensing beam and the mounting frame, wherein each of front and back surfaces of receiving sensor portions adhere with each of orthogonal shearing type strain gauges A1 to H4, and a signal is derived from the strain gauges A1 to H4 by a bridge circuit for each receiving sensor portion, and the output signals from the bridge circuit are sampled by an electronic circuit disposed on the inside of a rotating unit according to the timing signal from an angle detection signal, and the output signals are transmitted to a signal processing unit disposed on the outside of the rotating unit by non-contact data transmission method, and the output signals are corrected by correction information for every rotation angle position of the detector storing the output signals beforehand, and are subjected to coordinate conversion so as to calculate the six component forces for every angle rotation.

### BACKGROUND OF THE INVENTION

1. Field of the Invention

The present invention relates to a rotary component force measuring device for measuring six component forces of Fx, Fy, and Fz applied in axial directions x, y and z of an orthogonal coordinate system and running torques (moments) Mx, My and Mz acting around these axes.

2. Related Background Art

Regarding to the techniques that involve detecting multiple component forces, there are many prior art references. For example, Japanese Patent Application Laid-Open No.05-256710 discloses a multiple component force detector which aims to obtain a detector of multiple components of force which is highly accurate with high reproducibility and simple in structure without generating interferences among components of force, thereby to reduce the manufacturing cost. Japanese Patent Application Laid-Open No.06-265423 discloses a multi component force detector which aims to provide a multi component force detector by which measurement having high accuracy and reproducing ability can be executed for the six component forces at the maximum without mutual interference. Japanese Patent Application Laid-Open No.10-332502 discloses a six component forces load cell which aims to facilitate fixing and shaping of a strain gauge while reducing the mutual interference error by making a hole for leading out I/O lines on one side of a lower case. Japanese Patent Application Laid-Open No.2003-050171 discloses a method and apparatus for measuring multi-component force which aims to provide a method and an apparatus for measuring a multi-component force which eliminates the problem of a complexion of a bridge circuit wiring of a strain gage and a zero-point change, and which reduces a mutual interference between component forces for improving measurement accuracy. Japanese Patent Application Laid-Open No.2004-045138 discloses a force component meter which aims to provide a force component meter performing correctly external force introduction with an operation rod and realizing thickness reduction as well without generating mechanism errors with time, and furthermore, upgrading reliability and duration by making distortion occurrence parts into a beam structure with high rigidity.

As a multiple component force detector which constitutes a multiple component force measuring device, there has been a multiple component force detector as disclosed in Japanese Patent Application Laid-Open No.3-6432.

The multiple component force detector disclosed in this Laid-Open No.3-6432 comprises: a fixed flange; a load side flange coaxially disposed in a center axis of the fixed flange; a receiving sensor portion of a rectangular square rod which extends in a radial direction with an angle of 90 degree held and comprises upper and lower surfaces vertical to the center axis and a side surface vertical to the upper and lower surfaces; a constricted unit narrowing a section coupled with the receiving sensor portion and short in width; and a detector main body coupling both ends with the fixed flange and integrally forming four sheets of laminated elastic joints vertically extending to the center line of a radial direction of the receiving sensor portion, wherein each surface of the load side flange side of the receiving sensor portion is adhered with at least two sheets of strain gauges, thereby constituting a bridge circuit corresponding to a component of each force and a running torque.

However, the multiple component force measuring device comprising such a multiple component force detector had technical problems as described below.

Since the multiple component force detector as disclosed in the Laid-Open No.3-6432 has a receiving sensor portion in the shape of a rectangular square rod, an adhering section of a strain gauge is quadrangle. Hence, a force F which is an output of the strain gauge to be primarily detected has been applied with the maximum strain by a side force Fs, thereby having caused a large interference to become a detection error factor of the force F.

Further, in the multiple force component detector, the wiring of one bridge circuit has been laid across a plurality of receiving sensor portions, and the lengthening of the wiring not only has become a detection error factor of the component forces, but since errors based on strain gauge characteristics of a plurality of receiving sensor portions were added to each component of the component forces, it has been also difficult to correct each component of the component forces after the component forces were found by the bridge circuit, and no correct component forces have been found.

Moreover, to find the multiple component forces, though the component forces are found by the bridge circuit, to accomplish this, a simple addition or subtraction has been performed, and therefore, it has been necessary to dispose the receiving sensor portion by four beams, and this has been an enormous structural restraint on the multiple component force detector. Further, if constituted by other than four beams, an extremely complicated component force detection circuit would have been required, and therefore, its realization has been difficult.

### SUMMARY OF THE INVENTION

The present invention has been made in view of the conventional problems as described above, and an objective of the invention is to provide an rotary type component force measuring device, which can reduce a detection error of the strain gauge and can find a correct and highly accurate component force.

The most important solving means of the present invention lies in that it is not the system of converting the strain gauge signal of the conventional receiving sensor portion into a component force value by a bridge circuit and then transmitting the data to a signal processing unit, but the system of data-transmitting a signal for each and every receiving sensor portion to the signal processing unit as it is as data so that the data is corrected by using a high speed arithmetic function in the signal processing unit and a component force value is found by coordinate-conversion accompanied with a receiving sensor portion structure.

In this manner, a rotary type component force measuring method and a rotary type component force measuring device capable of performing the correction for each and every receiving sensor portion can be provided only by changing the number of data transmission signals corresponding to the quantity, structure, and arrangement of the receiving sensor portion, and changing the calculation method of the signal processing unit.

For example, different from the conventional rotary type component force detection having a four-beam shape, the rotary type component force detection corresponding to the beam structure of four, five, six, seven, and the like which are used in the ordinary wheel structure can be performed.

To attain the above objective, the rotary type component force measuring device of the present invention aims to measure forces Fx, Fy, and FZ applied in x, y, and z axial directions of an orthogonal coordinate system and torques Mx, My, and Mz acting around these axes and has a rotary type component force detector comprising, in integrated manner: an annular rim mounting frame connected to a rim of a wheel as a rotating unit; a hub mounting frame having a mounting unit to the hub disposed in the center of said rim mounting frame; at least three first sensing beams each of which is a sheet elastic joint, each of said first sensing beams linking with said rim mounting frame; at least three second sensing beams linking with said hub mounting frame, each of said second sensing beams linking with a corresponding one of said first sensing beams. And, the present invention measuring device is configured to operate in such a way that an orthogonal shearing type strain gauge adheres to each of front and back surfaces of a receiving sensor portion formed in each of said first sensing beams and each of said second sensing beams to derive an orthogonal shearing type strain for each receiving sensor portion as an output signal from one of a plurality of bridge circuits disposed so as to correspond to respective receiving sensor portions, each of the derived output signals is digitalized by an AD converter, and the digitalized output signals are transmitted to a signal processing unit disposed on the outside of said rotating unit by means of non-contact data transmission such as electromagnetic coupling, optical data transmission or radio transmission or by means of contact data transmission such as a slip-ring and the like, and said signal processing unit operates to correct each of the output signals transmitted from said bridge circuits corresponding to respective receiving sensor portions on the basis of correction information stored beforehand and to subject the corrected signals to coordinate-conversion so as to calculate the six component forces of a orthogonal coordinate system.

From another view point, the present invention's rotary type component force measuring device has a rotary type torque detector comprising, in integrated manner: an annular rim mounting frame connected to a rim of a wheel as a rotating unit; a hub mounting frame having a mounting unit to the hub disposed in the center of said rim mounting frame; and at least three sensing beams linking with said rim mounting frame and said hub mounting frame, wherein each of said sensing beams has two mutually opposed surfaces each formed with a concave portion, and with both bottoms of said concave portion taken as a first receiving sensor portion and both side surfaces thereof as a second receiving sensor portion, an orthogonal shearing type strain gauge adheres to each of said first and second receiving sensor units to derive an orthogonal shearing type stain for each receiving sensor portion as an output signal from one of a plurality of bridge circuits disposed so as to correspond to respective receiving sensor portions, each of the derived output signals is digitalized by an AD converter, and the digitalized output signals are transmitted to a signal processing unit disposed on the outside of said rotating unit by means non-contact data transmission such as electromagnetic coupling, optical data transmission or radio transmission or by means of contact data transmission such as a slip-ring and the like, and wherein said signal processing unit operates to correct each of the output signals transmitted from said bridge circuits corresponding to respective receiving sensor portions on the basis of correction information stored beforehand and to subject the corrected signals to coordinate-conversion so as to calculate the six component forces of an orthogonal coordinate system.

According to the rotary type component force measuring device thus constituted, since the output signal is taken out for every receiving sensor portion, in a state in which detection independency for every receiving sensor portion and non-interference property between different receiving sensor portions are maintained, a correct correction is performed according to characteristic of strain gauge for every output signal and different deformation for every receiving sensor portion, whereby a high accuracy of the component force calculation can be attempted.

Preferably, each of the second sensing beams has a character I shaped sectional shear beam type structure.

Since the character I shaped sectional shear beam type is adapted in this manner, comparing to an arm having a square type section, the effect of a shearing component due to the side force Fs applied on the sensitive surface can be reduced, and a highly accurate output signal can be obtained from the shear gauge.

It is preferable that the output signal from each of said bridge circuits is sampled by an electronic circuit disposed on the inside of said rotating unit according to a timing signal obtained from an rotation angle detection signal, before the digitalization by said AD converter, and wherein said signal processing unit operates to perform the correction based on correction information for each of rotation angles in said rotary type component force detector and to calculate the six component forces of an orthogonal coordinate system for each of rotation angles. Preferably, said correction information may be information including a primary order correction or a higher order correction incorporating a rotational deformation according to the rotation of said rotary type component force detector.

Thus, according to the rotary type component force measuring device of the present information, since eight output signals are simultaneously sampled for every rotation angle, a quantization error of the rotation angle is controlled, and at the same time, the output signals of all rotation angles can be obtained at a high speed, so that the errors of the output signals and the six component forces are reduced, and correctly high accurate component forces can be found for every rotation angle.

Furthermore, it is preferable that said signal processing unit applies known six component forces from the outside for every rotation angle of said wheel in a resting state, and has a coordinate conversion circuit for converting said output signal into said six component forces based on a conversion matrix obtained by measuring bridge signals at that time.

By finding the conversion matrix in advance in this manner, the conversion of a plurality of output signals into the six component forces can be quickly performed, thereby contributing to the speeding up of the signal processing.

Further, the signal processing unit may have a filter for converting the six component forces into the component forces of an actual rotational coordinate system including a tire.

According to this constitution, since information on the component forces of the actual rotational coordinate system and the rotation angles are obtained, it can be used for various applications such as analysis of vehicle behaviors in a starting time and a stopping time of the vehicle by a brake pedal and the like, ride quality improvement analysis for minute road surface changes in traveling, collection of simulation data of virtual road surfaces and vehicle vibrations, and the like.

According to the rotary type component force measuring device according to the present invention, the output signal is sampled at the wheel side according to the timing signal obtained for every receiving sensor portion, and in a state in which detection independency for every receiving sensor portion and non-interference property between different receiving sensor portions are maintained, a correction of the output signal is performed according to characteristic of strain gauge for every receiving sensor portion, and then, the output signal is coordinate-converted into six component forces, thereby realizing a high precision of the six component forces. Moreover, since the bridge circuit is constituted for every receiving sensor portion, the wiring needs not to be lengthy, and the signal error accompanied with the wiring is reduced.

Further, since the character I shaped sectional shear beam type arm is adapted, comparing to the arm having a quadrangular section, the effect of the strain component due to the side force Fs applied on the sensitive surface can be reduced, and a high accurate output signal can be obtained from the strain gauge.

Further, each signal for every receiving sensor portion is data-transmitted to the signal processing unit as it is, and a component force value is found by data correction and coordinate-conversion accompanied with the receiving sensor portion structure by using high speed calculation function at the signal processing unit, so that a rotary type component force measuring device capable of performing the correction for each and every receiving sensor portion can be provided only by changing the number of data transmission signals corresponding to the quantity, structure, and arrangement of the receiving sensor portion, and changing the calculation method of the signal processing unit.

### BRIEF DESCRIPTION OF THE DRAWINGS

FIG. 1 is a top view and a sectional side view showing one embodiment of a rotary type component force detector;

FIG. 2 is an oblique view removing one unit of an arm of FIG. 1;

FIG. 3 is a structural drawing showing one embodiment of a bridge circuit;

FIG. 4 is a structural drawing showing another embodiment of the bridge circuit;

FIG. 5 is a conceptual illustration showing a difference between an arm of a character I shaped sectional shear beam type and an arm having a quadrangular section;

FIG. 6 is a structural drawing showing one embodiment of a rotary type component force detection measuring device;

FIG. 7 is a structural drawing showing one embodiment of a signal processing unit;

FIG. 8 is a top view and a sectional side view showing another embodiment of the rotary type component force detector;

FIG. 9 is an oblique view removing one unit of the arm of FIG. 8;

FIG. 10 is an exploded oblique view showing one example of a mounting method of a rotary type component force detector to a rim and a hub; and

FIG. 11 is a top view showing another embodiment of the rotary type component force detector.

### DESCRIPTION OF THE PREFERRED EMBODIMENTS

Preferred embodiments of the present invention will be described below in detail with reference to the accompanying drawings. A rotary type component force measuring device 1 of the present invention is a device which measures forces Fx, Fy, and Fz applied in the orthogonal coordinate system three directions of a wheel axle located in the center of a wheel and the orthogonal coordinate system six component forces of torques Mx, My, and Mz acting around these axes accompanied with the rotation of the wheel which is a measuring object at least by a rotary type component force detector 11 fixed to the wheel, a strain gauge disposed in the sensing beam of the rotary type component force detector 11, and a bridge circuit constituted by the gauge.

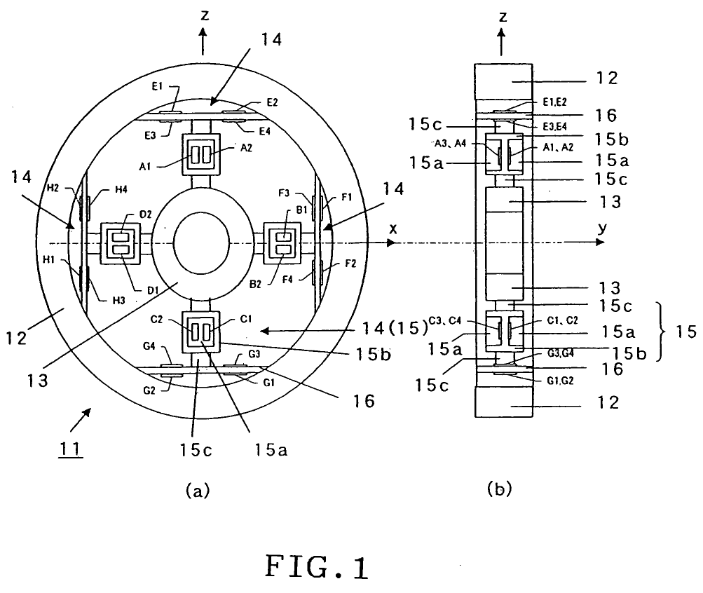

FIG. 1 is a structural illustration showing a rotary type component force detector 11 and one embodiment of the arrangement of strain gauges A1 to H4 disposed in sensing beams 15 and 16 of the rotary type component force detector 11 from among the rotary type component force measuring device 1 of the present invention, and FIG. 1A is a x-z top view, and FIG. 1B is a y-z sectional side view seen from an x axial direction.

The rotary type component force detector 11 shown in FIG. 1 comprises: an annular rim mounting frame 12 mounted on the rim of a wheel as a rotating unit; an annular hub mounting frame 13 coaxially provided with the rim mounting frame 12 and mounted on a hub of the wheel; and four T-character type arms 14 disposed in the shape of a cross between the rim mounting frame 12 and the hub mounting frame 13, and these components are all integrally formed. The rotary type component force detector 11 of the present embodiment is formed of a super hard steel material such as duralumin and the like in order to measure the six component forces applied on the wheel.

The shapes of the rim mounting frame 12 and the hub mounting frame 13 may be shapes suitable for the shapes of the rim and the hub or mountable to the rim through a rim adaptor, and there is no need to be annular.

One example of a mounting method of the rotary type component force detector 11 on the rim and the hub is shown in FIG. 10. The rotary type component force detector 11 shown in FIG. 10 is mounted on the rim 4 and the hub 5 by bolts 6 through a rim adaptor 4a and a hub adaptor 5a. Reference numeral 7 denotes a slip ring.

An arm 14 is a receiving sensor portion of a strain received from the outside of the wheel, and is disposed by adhering a sensor (orthogonal shearing type strain gauges A1 to H14 in the present embodiment) on the sensitive surface, and detects a strain applied vertically on the sensitive surface. The type of the sensor may be other than the strain gauge, and the type of the strain gauge may be a beam type in addition to the orthogonal shearing type.

The arm 14 of the present embodiment is constituted by two sensing beams of the first sensing beam 16 and the second sensing beam 15.

The first sensing beam 16 is a square pole coupled with the rim mounting frame 12, and is an elastic joint in a form of shape constituted by strain gauges E1 to H4 adhered on each of two surfaces opposed to the square pole.

The second sensing beam 15 is a character I shaped sectional shear beam type sensing beam having a character I shaped sectional unit 15b, in which one end is coupled with the fist sensing beam 16, and the other end to the hub mounting frame 13, and each of the opposed two surfaces are formed with a concave portion 15a, and both bottoms of the concave portion 15a which is an elastic unit are adhered with orthogonal shearing type strain gauges A1 to D4.

The second sensing beam 15, as shown in FIG. 1, may have a square pole shaped constricted unit 15c thinner than the outer diameter of the character I shaped sectional unit 15b at both ends coupled with the hub mounting frame 13 and the sensing beam 16. The presence or absence of the constricted unit 15c is arbitrary in the present invention, and the second sensing beam 15 may be formed by a single square pole having no constricted unit 15c.

In FIG. 1, from among the four arms 14, though a detailed reference number is attached to one arm only, since the same applies to the remaining arms 14, the description thereof will be omitted.

Further, with regard to the structure of the rotary type component force detector of the present invention, the arrangement and the quantity of the second sensing beam 15 may be disposed at least three or more beams. However, here will be shown a specific example by four beams of the character I shaped structure usually in a lot of use. Further, the present embodiment is an example in which the output signals of the receiving sensor portion as to be described later are eight beams.

Describing a definite method of adhering the strain gauge, the strain gauges of A1 to A4 and D1 to D4 are adhered to both bottoms of two concave portions 15a of the second sensing beam 15 (receiving sensor portion) at positions mutually opposed, respectively. In the present embodiment, for example, A1 and A2 are lined up in parallel along a longitudinal direction of the first sensing beam 16 on the one surface, and A3 and A4 are adhered on the other surface, and A1 and A3, and A2 and A4 are mutually opposed.

Further, the strain gauges of E1 to E4 through H1 to H4 are adhered on both ends of the two sides of the surface which forms the first sensing beam 16 (receiving sensor portion) at positions mutually opposed. In the present embodiment, for example, E1 and E2 are adhered on the one surface, and E3 and E4 are adhered on the other surface, and E1 and E3, and E2 and E4 are mutually opposed.

In this manner, each of the arms 14 has two sensing beams 15 and 16, and in the present embodiment, one rotary type component force detector 11 in FIG. 1 has a total of eight receiving sensor portions which are formed on each of a total of eight sensing beams 15 and 16. The strain gauge signal obtained from each receiving sensor portion (sensing beams 15 and 16), as shown in FIG. 3, is taken out, as an output signal from a total of eight bridge circuits constituted for every receiving sensor portion.

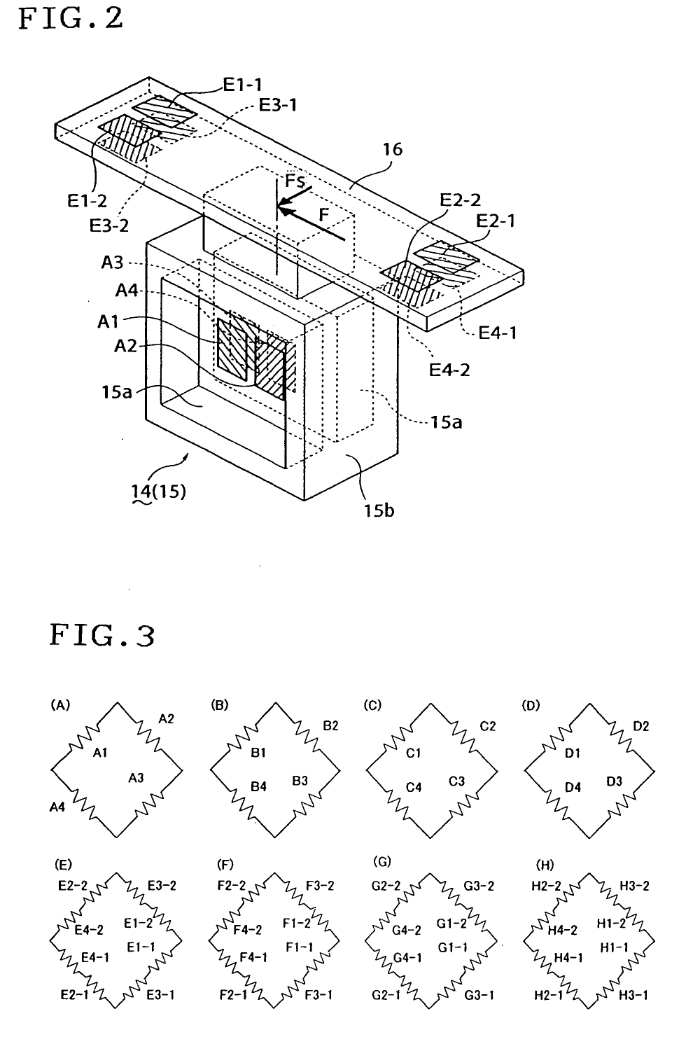

FIG. 2 is an oblique view showing one unit of the arm 14 shown in FIG. 1 removed. Each of the strain gauges of E1 to E4 through H1 to H4 adhered to the first sensing beams 16 of the rotary type component force detector 11 of the present embodiment are constituted by a pair of two sheets. The two sheets of the strain gauges (for example, El-1 and E1-2) are adhered side by side along a short side direction at the end unit of the first sensing beam 16.

In the bridge circuits shown in FIGS. 3(A) to 3(D), a strain in a radial direction (axial direction of the arm 14) from the hub mounting frame 13 is selectively received for every second sensing beam 15, and a force other than that, for example, a force vertical to the radial direction is cancelled by the two sheets of the strain gauges mutually opposed.

Further, in the bridge circuits shown in FIGS. 3(E) to 3(H), a strain parallel to the z axial direction (wheel axial direction of the wheel) is selectively received for each and every first sensing beam 16, and a force other than that, for example, a component force vertical to the z axial direction is cancelled by the two sheets of the strain gauges mutually opposed.

In this manner, the output signal obtained from the strain gauge is taken out by the bridge circuit for every receiving sensor portion, so that, different from the conventional system in which the six component forces of three forces (Fx, Fy, and Fz) in an orthogonal three axial direction and three torques (Mx, My, and Mz) around each axis are taken out at one stretch as output signals from the six bridge circuits, these six component forces are strictly transmitted to second processing means to be described later as the output signals of the strain gauge for every receiving sensor portion with characteristic of the strain gauge for every receiving sensor portion and interference (error) characteristic of the strain gauge between different receiving sensor portions kept as they are.

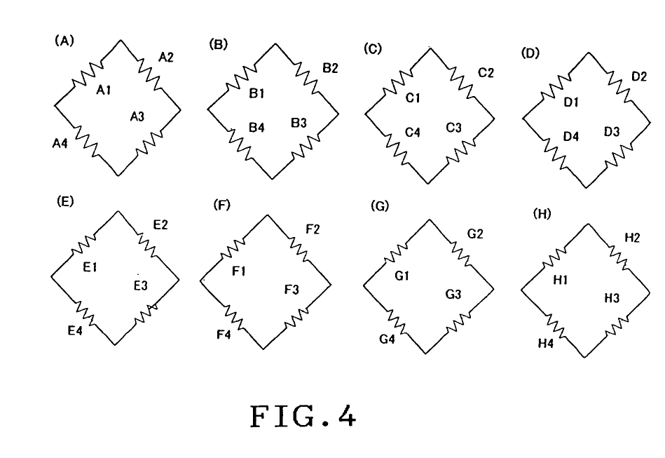

A structural example of the bridge circuit in case each of the strain gauges E1 to E4 through H1 to H4 of the first sensing beam 16 are constituted by one sheet each, is shown in FIG. 4. Even in this case, the number of bridge circuits remains unchanged to be a total of eight.

Here, the second sensing beam 15, which is one of the features of the present invention, as described above, has the character I shaped sectional unit 15b, and the strain gauges A1 to D4 are disposed on the bottom of the concave portion 15a which forms the character I shaped sectional unit 15b. Now, this advantage will be described below.

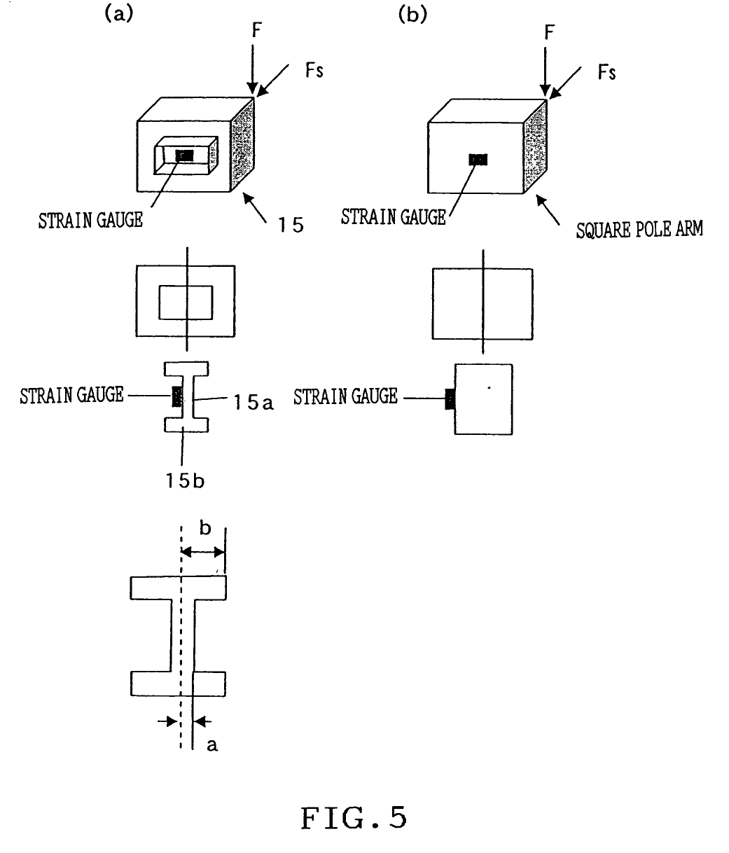

Heretofore, as the shape of the sensing beam, a square pole shape has been known. One example in which the strain gauge is adhered on the square pole sensing beam is shown in FIG. 5(B). As shown in FIG. 5(B), the sectional shape of the square pole shaped sensing beam is naturally quadrangular. Hence, because the force F, which is an output of the strain gauge to be primarily detected, has the maximum strain applied by a side force Fs, there occurs an enormous interference, and this becomes an error.

In the meantime, the second sensing beam 15 having the character I shaped sectional unit 15b shown in FIG. 5(A) has the character I shaped section formed by two concave portions 15a, and the strain gauge is adhered to the bottom of the concave portion 15a, that is, close to the center of the character I shaped section, and therefore, no maximum strain is applied to the force F to be primarily detected by the side force Fs, and the interference is few.

Here, in FIG. 5(A), assuming that the distance from the center of the character I shaped section to the adhered surface of the strain gauge is taken as A, and the distance in which the depth of the concave portion 15a is added to a is taken as B, the relation between the maximum strain εₘₐₓ by Fs and the gauge strain ε_{gage} applied to the strain gauge is expressed by ε_{gage}−εₘₐₓ×(A/B).

For example, if the second sensing beam 15 is formed so that a ratio of a to b becomes b−10a, the effect of the maximum strain applied to the strain gauge can be controlled to one tenth by comparing to the case of the square pole shaped sensing beam.

Further, as the shape of the sensing beam, in addition to the square pole shape, there is also known a Roberval (eye glasses) shape. Although the rotary type torque detector of the Roberval shape is highly accurate, its deflection is as large as 0.1 to 0.5 mm, and since the maximum range of a load cell is approximately up to 600 kg, the shape of the sensing beam ends up becoming as large as 60×60×250 mm.

In the meantime, in the case of the second sensing beam 15 having the character I shaped sectional unit 15b, the deflection is equal to or less than 0.05 mm, a signal processing response of the output of the strain gauge becomes a high speed. Moreover, even if the size is 40×40×150 mm, the maximum range of approximate 500 kg to 3 tons can be obtained, so that the miniaturization of the beam can be accomplished. In this manner, the second sensing beam 15 having the character I shaped sectional unit 15b is advantageous even when comparing to the Roberval shaped sensing beam.

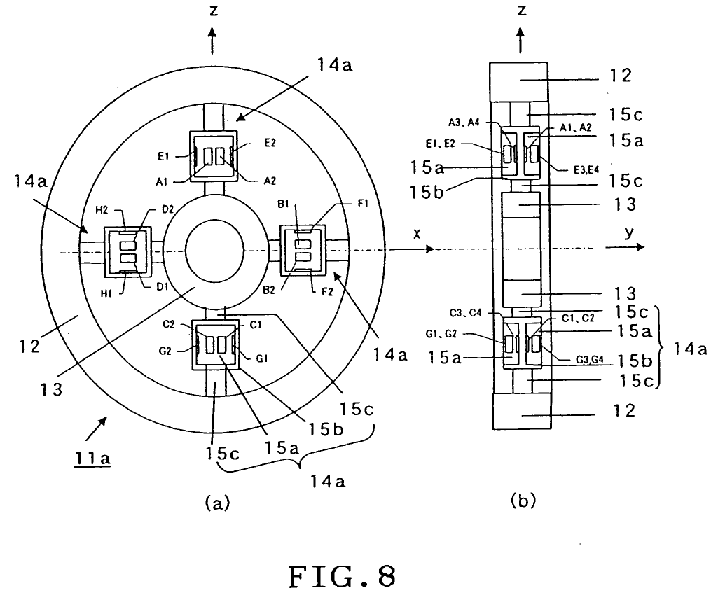

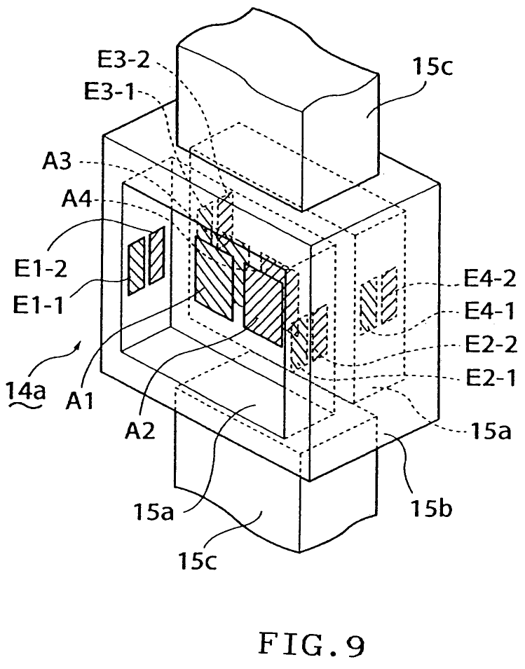

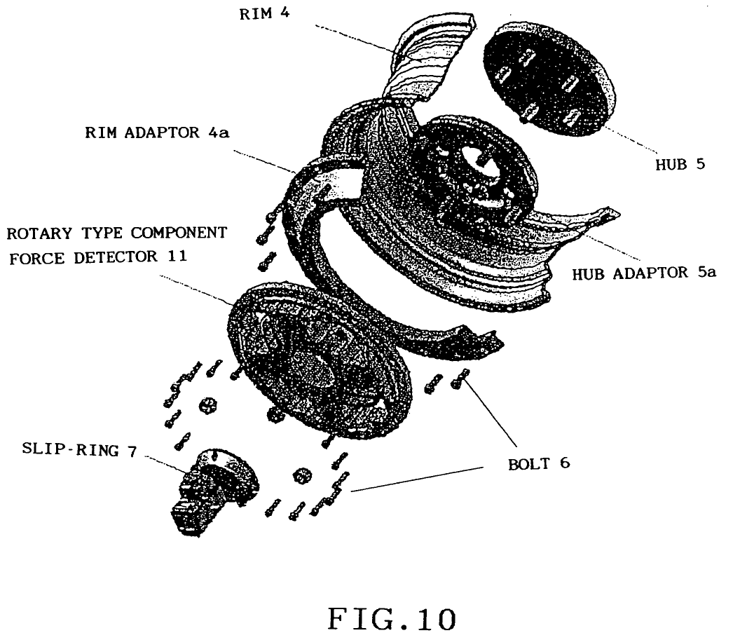

FIG. 8 is a top view and a sectional side view showing another embodiment of the rotary type component force detector 11, and FIG. 9 is an oblique view of a removed unit of an arm 14a of the character I shaped sectional shear beam type from among the rotary type component force detector 11a of FIG. 8. In either of the drawings, the adhering examples of the strain gauges A1 and A2 to H1 and H2 are shown. Moreover, the strain gauges up to E1, E2 to H1, and H2 are constituted by two sheets each. (For example, E1 consists of two sheets of E1-1 and E1-2). In FIG. 8, from among four arms 14a, though a detailed reference numeral is attached to one arm only, since the same applies to the remaining arms 14a, the description thereof will be omitted.

The difference between the rotary type component force detector 11a shown in FIGS. 8 and 9 and the rotary type component force detector 11 shown in FIGS. 1 and 2 is that the second sensing beam 15 and the first sensing beam 16 are either integrated or separated.

The rotary type component force detector 11a shown in FIGS. 8 and 9 is constituted such that the orthogonal shearing type strain gauge is adhered not only to the bottom of the contact unit 15a which forms the character I shaped sectional unit 15b, but also to the side surface, and the receiving sensor portion is formed on both bottoms and both side surface of the concave portion 15a, and both bottoms are equivalent to the second sensing beam 15, and both side surfaces are equivalent to the first sensing beam 16. That is, as the number of receiving sensor portions, it is eight in total, and is not different from the number of receiving sensor portions in the rotary type component force detector 11 of the preceding embodiment. The strain gauge adhered to the side surface selectively senses a strain in parallel to the direction of the z axis, and a force other than that, for example, the component vertical to the direction of the z axis is cancelled by the two sheets of the strain gauges mutually opposed.

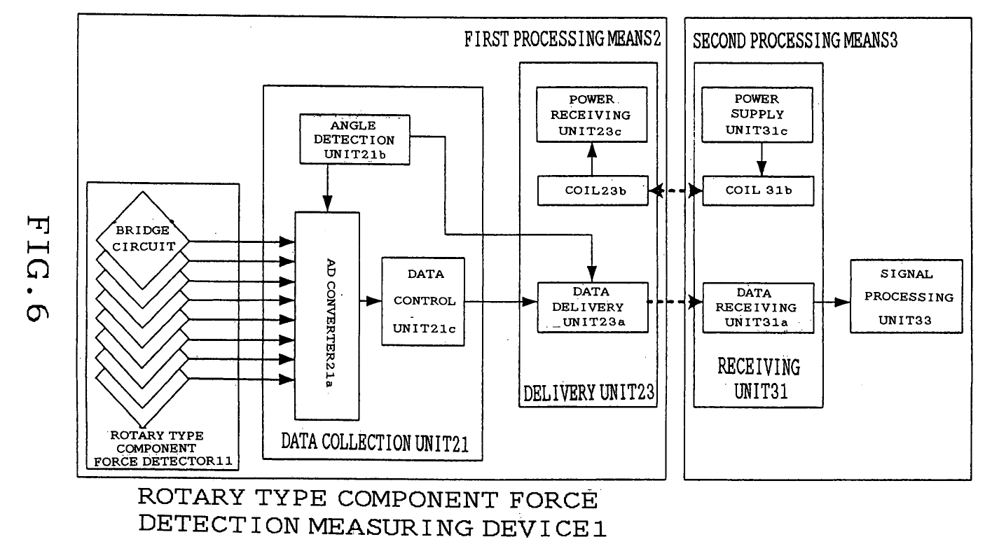

Next, one example of the constitution of the rotary type component force measuring device 1 including the rotary type component force detector 11 is shown in FIG. 6. The rotary type component force measuring device 1 shown in the drawing is constituted by first processing means 2 which is installed inside the rotating unit (wheel) which is a measuring object, and samples the output signal from the bridge circuit constituted for each of eight receiving sensor portions according to a timing signal obtained from an rotation angle detection signal of the wheel and the second processing means 3 which is outside of the rotation unit and is installed at a position (for example, a data collection chamber, an experimental laboratory, a control chamber, a computer installation chamber, and the like) apart from the first processing means 2 and receives the output signals sampled by the first processing means 2, and corrects the signals individually based on the characteristic of the strain gauge for every receiving sensor portion and the interference characteristics of the strain gauges between different receiving sensor portions, and calculates the six component forces for each rotation angle.

The first processing means 2 is constituted by a data collection unit 21 and a delivery unit 23 in addition to the rotary type component force detector 11, and the second processing means 3 is constituted by a receiving unit 31 and a signal processing unit 33.

The data collection unit 21 is means which inputs eight signals from the rotary type component force detector 11, and samples and AD-converts them according to the timing signal obtained from the rotation angle detection signal, and is constituted by an electronic circuit such as an AD converter 21a, an angle detection unit 21b, and a data control unit 21c.

The angle detection unit 21b is means, which detects the rotation angle of the wheel which is a measuring object by the relative position detection of the first processing means 2 and the second processing means 3. The angle detection unit 21b can be realized by a detector (rotary encoder) of an encoder system using a light, magnetism, and electromagnetism, and may be those known conventionally.

For example, the angle rotation detection unit 21b of an optical encoder system fixes a circular slit plate curved with slits on the periphery to the first processing means 2 for every rotation reference position and detection angle (for example, one degree), and disposes a projection element and a light receiving element in the second processing means 3, so that rotation reference position information and angle information are outputted by a pulse train depending on the rotation angle, and this is read by a pulse counter, and is aligned with the rotation reference position information, thereby obtaining a rotation angle timing signal for every micro angle from 0 to 360 degree.

In the present embodiment, the AD converter 21a is inputted with a timing signal generated for every rotation angle (for example, 0.5 degree, one degree, and the like) from the angle detection unit 21b, and the AD converter 21a samples the output signal which is an input data according to the timing signal obtained from this rotation angle detection signal, and digital-outputs a total of eight output signals. The electronic circuit (or data control unit 21c) disposed inside the first processing means 2 may sample the output signal for every rotation angle, and the time sequence context between the operation of the AD converter 21a and the operation of the angle detection unit 21b, and a sampling method for every rotation angle are not limited to the present embodiment.

In this manner, since eight output signals are simultaneously sampled for every rotation angle, the quantization error of the rotation angle is controlled, and at the same time, the output signals of all the rotation angles can be obtained at a high speed. Further, a sampling frequency (resolution of the rotation angle) can be varied according to the processing time required.

The data control unit 21c is means, which performs the control of the AD converter 21a and the angle detection unit 21b, and classifies the output of the AD converter 21a for every angle detected by the rotation angle detection unit 21b so as to transfer it to the delivery unit 23.

The delivery unit 23 is means, which delivers the output signal collected by the data collection unit 21 to the second processing means 3, and the receiving unit 31 is means, which receives the output signal delivered from the delivery unit 23 together with the rotation angle information by the angle detection unit 21b. The delivery unit 23 has a data delivery unit 23a, a coil 23b, and a power receiving unit 23c, and the receiving unit 31 has a data receiving unit 31a, a coil 31b, and the power supply unit 31c.

In the present embodiment, the transmission of the output signal of the first processing means 2 to the second processing means 3 is performed by non-contact. At this time, this transmission is preferable to be performed by the change of the transmission route accompanied with the rotation of the digitalized output signal, electromagnetic coupling having few effect of the error due to electromagnetic noise to be generated and the like, an optical data transmission, a system of radio transmission and the like.

In addition to the non-contact system, the transmission may be performed by a contact system such as the slip-ring and the like conventionally used in case of measuring the six forces of the wheel. According to the transmission of the contact system, an existing facility can be put to practical use.

Further, eight digitalized output signals may be converted into serial data and directly ASK-modulated and transmitted or may be FSK and PSK-modulated as eight-channel multiplexing signals and transmitted. In addition to the serial transmission, the signals may be parallel-transmitted. Further, such data modulation may be performed by the data control unit 21c.

The delivery unit 23 and the receiving unit 31 are disposed at separate places such as the first processing means 2 (inside the rotating unit) and the second processing means 3 (outside the rotating unit), respectively, and moreover, in general, there is no power generating place in the measuring object such as the wheel and the like. Hence, each unit is installed with coils 23b and 31b, and the power supplied from the power supply unit 31c of the receiving unit 31 side is transferred to the coil 23b of the delivery unit 23 by electromagnetic induction through the coil 31b. A power receiving unit 23c of the delivery unit 23 perform a power conversion by electromagnetic induction of the coil 23b, and the power is supplied to each unit requiring the power inside the first processing means 2. The power supplying method to the inside of the first processing means 2 is not limited to the above described method, but can utilize the publicly known technique.

The signal processing unit 33 is means, which finds the six component forces of the orthogonal coordinate system from a total eight output signals received from the receiving unit 31, and moreover, finds the six component forces of an actual rotational coordinate system (vehicle running coordinate system) of the measuring object including the tire and the like from the six component forces of the orthogonal coordinate system (wheel coordinate system).

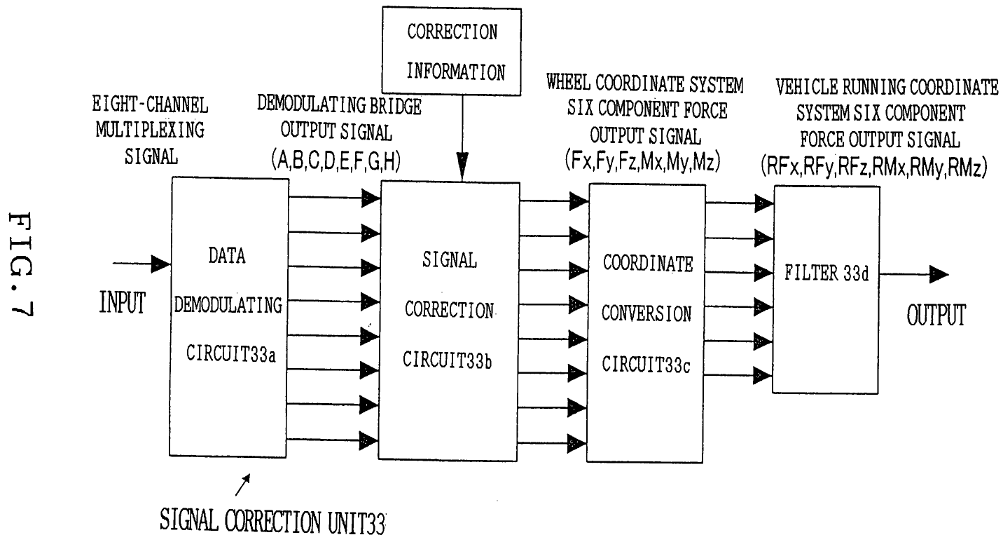

One example of the detailed constitution of the signal processing unit 33 is shown in FIG. 7. The signal processing unit 33 shown in the drawing has a data demodulator circuit 33a, a signal correction circuit 33b, a coordinate conversion circuit 33c, and a filter 33d. The description of the following each unit will be made as one embodiment in case of finding the six component forces applied to the wheel.

The data demodulator circuit 33a is means, which demodulates the output signal modulated and transmitted (one eight-channel multiplexing signal in the present embodiment) into a total of eight output signals (A, B, C, D, E, F, G, and H).

The signal correction circuit 33b is means, which corrects the output signal based on correction information (correction coefficient) for every angle position of the rotary type torque detector 11 stored in advance. The presence or absence of the signal correction circuit 33b is arbitrary. The signal correction circuit 33b may be constituted by the publicly known technique. For example, the output signals of the rotary type torque detector 11 when the known output signals are given as a load are read, and these signals are comparison-operated so as to find a correction coefficient for representing a cross correlation, thereby storing it in a memory and the like.

Since the output signal is inputted to the signal correction circuit 33b, while keeping the characteristic of the strain gauge for every receiving sensor portion and the interference characteristic (error) of the strain gauge between different receiving sensor portions, a correct correction according to the characteristic of the strain gauge for every output signal and the different deformation for every receiving sensor portion is performed, and the calculation of the subsequent component forces can be performed with a high accuracy. The correction is sufficient even if it is a linear primary correction, and particularly there is no need for a high-grade correction.

To reduce calculation errors of the component forces much further, the coefficient of the correction information may be adjusted so as to be most close to the theoretical value of each output signal or the product of the nth term of the output signal and each term may be added as a correction term, thereby performing the correction. At this time, each collection term may be put together to become correction matrices so as to perform calculation. Further, a high order correction, which incorporates a rotation deformation depending on the rotation of the rotary type torque detector 11, may be performed.

In this manner, prior to the component force calculation not subsequent to the component force calculation, in a state in which detection independency for every receiving sensor portion and non-interference property between different receiving sensor portions are maintained, the correction according to the characteristic of the strain gauge for each output signal and different deformation for every receiving sensor portion is performed, and therefore, the correction calculation is easily performed, and adequacy of the correction is increased, and correct highly accurate component forces are found.

The coordinate conversion circuit 33c is means, which coordinate-converts a total of eight demodulated output signals into the six component forces of the wheel coordinate system (orthogonal coordinate system) for every rotation angle. In the present embodiment, the conversion is performed by matrix algebra shown by the following expression.

$$( \begin{matrix} Fx \\ Fy \\ Fz \\ M x \\ My \\ Mz\end{matrix} ) = ( \begin{matrix}{K}_{11} & {K}_{12} & {K}_{13} & {K}_{14} & {K}_{15} & {K}_{16} & {K}_{17} & {K}_{18} \\ {K}_{21} & {K}_{22} & {K}_{23} & {K}_{24} & {K}_{25} & {K}_{26} & {K}_{27} & {K}_{28} \\ {K}_{31} & {K}_{32} & {K}_{33} & {K}_{34} & {K}_{35} & {K}_{36} & {K}_{37} & {K}_{38} \\ {K}_{41} & ⋯ & ⋯ & ⋯ & ⋯ & ⋯ & ⋯ & {K}_{48} \\ {K}_{51} & ⋯ & ⋯ & ⋯ & ⋯ & ⋯ & ⋯ & {K}_{58} \\ {K}_{61} & ⋯ & ⋯ & ⋯ & ⋯ & ⋯ & ⋯ & {K}_{68}\end{matrix} ) * ( \begin{matrix}A \\ B \\ C \\ D \\ E \\ F \\ G \\ H\end{matrix} ) \qquad [ Expression 1 ]$$

Here, Fx to Mz are the six component forces of the forces Fx, Fy and Fz applied in the directions of x, y, and z axes of the orthogonal coordinate system of the wheel, and the torques Mx, My and Mz acting around these axes. The output signals A to H, while keeping the characteristic of the strain gauge for every receiving sensor portion and the interference characteristic (error) of the strain gauge between different receiving sensor portions, are inputted to the signal correction circuit, and therefore, a correct correction is performed according to the characteristic of the strain gauge for every output signal and the different deformation for every receiving sensor portion, thereby contributing to a correct component force calculation. The output signals K₁₁ to K₆₈ for every receiving sensor portion are conversion matrices (matrix for conversion).

These conversion matrices are obtained by adding the known six component forces from the outside of the wheel to the rotary type torque detector 11 to be used in advance in a resting state for every rotation angle (for example, one degree) of the wheel, and measuring the output signals A to H at that time, and finding correlation among these signals, and the obtained conversion matrices are stored in the memory and the like as one of the correction information. The conversion matrices of the present embodiment are as follows.

$$k1 = ( \begin{matrix}- 3587 & 29 & - 9 & - 3 & - 301 & 187 \\ 7 & 24 & - 3604 & - 188 & - 302 & - 4 \\ 3577 & 21 & 9 & 3 & - 300 & - 186 \\ - 5 & - 17 & 3599 & 188 & - 303 & - 1 \\ 9 & - 7351 & 304 & 881 & 4 & - 18 \\ - 406 & - 7253 & 25 & - 22 & - 21 & 891 \\ - 1 & - 7430 & - 400 & - 856 & 4 & - 25 \\ 395 & - 7281 & 15 & - 14 & - 20 & - 857\end{matrix} ) \qquad [ Expression 2 ]$$

By finding the conversion matrices in this manner, the conversion from eight output signals into the six component forces can be quickly performed, thereby contributing to speeding up of the signal processing.

Further, based on the six component forces measured by mounting the rotary type torque detector 11 on the rim and the hub of the wheel fitted in the tire, a shape characteristic of the tire is found for every rotation angle, and is cancelled (setoff) from the six component forces of the orthogonal coordinate system found by the coordinate conversion circuit 33c, so that the six component forces not depending on the shape characteristic of the tire can be found.

The filter 33d is means, which converts the six component forces of the orthogonal coordinate system found by the coordinate conversion circuit 33c into the six component forces of the actual rotational coordinate system including the measuring object of the tire and the like so as to obtain the data at the rotational moving time of the wheel.

The relation among the forces in the orthogonal three axial directions acting on the wheel axis with the actual rotational coordinate system taken as a center of the wheel or the center of the wheel taken as a focal point (the force RFx in a longitudinal direction of the vehicle, the force Rfy in a lateral direction of the vehicle, and the force RFz in a vertical direction of the vehicle), the six component forces of the torques (RMx, RMy and RMz) around these axes, and the six component forces of the orthogonal coordinate system is represented by the following expression.

$$( \begin{matrix} RFx \\ RFy \\ RFz \\ RMx \\ RMy \\ RMz\end{matrix} ) = ( \begin{matrix}Cos θ & 0 & Sin θ & 0 & 0 & 0 \\ 0 & 1 & 0 & 0 & 0 & 0 \\ - Sin θ & 0 & Cos θ & 0 & 0 & 0 \\ 0 & 0 & 0 & Cos θ & 0 & Sin θ \\ 0 & 0 & 0 & 0 & 1 & 0 \\ 0 & 0 & 0 & - Sin θ & 0 & Cos θ\end{matrix} ) * ( \begin{matrix} Fx \\ Fy \\ Fz \\ M x \\ My \\ Mz\end{matrix} ) \qquad [ Expression 3 ]$$

Reference character θ denotes a rotation angle with the center of the tire taken as a focal point.

The constitution of the rotary type component force measuring device 1 as described above has the following merits comparing to the measuring device conventionally used. That is, conventionally, the six component forces were found at one stretch by the first processing means 2 by the difference or the sum of the output signals of the bridge circuit, and were transmitted to the second processing means 3, and the correction of the error factors and the like were performed by the second processing means 3.

However, the conventionally constituted bridge circuit has the wiring stretched across a plurality of the receiving sensor portions, and the lengthening of the wiring has become a detection error factor, as well as since errors based on strain gauge characteristics of a plurality of receiving sensor portions were added to each component of the component forces, and the six component forces ended up being calculated inside the rotating unit, no matter how corrected the six component forces were by the signal processing unit disposed outside of the rotating unit, those forces were no longer separated into a strain component for each and every receiving sensor portion, and the correction for different deformation by the weight of vehicle and the like for each and every receiving sensor portion was not possible, and the correct component forces were impossible to find.

Further, since error components generated at the output signal stage of the bridge circuit have been buried in each component of the component forces, after having found the component forces, the performing of the correction according to the characteristic of the strain gauge of individual receiving sensor portion and the interference characteristic of the strain gauge between different receiving sensor portions has become meaningless, and moreover, it was difficult to perform a high grade correction.

Further, as the biggest merit, there arises a degree of freedom with respect to the constitution of the rotary type component force detector. According to the bridge circuit of the component force detection type which is conventionally constituted, the finding of the component forces was only realized by the constitution in which four second sensing beams, that is, the second sensing beam is disposed for every 90 degree, and the strain gauge output is easy to add and subtract.

In contrast to this, in the rotary type component force detector of the present invention, since the finding of the component forces is performed by the calculation in the signal processing unit, if the number of the second sensing beams is equal to or more than three so as to be able to maintain the constitution, the component force detector can be freely constituted.

The rotary type component force measuring device 1 shown in FIG. 6 samples the output signal for every rotation angle for every receiving sensor portion inside the first processing means 2, and delivers the output signal from the delivery unit 23 to the second processing means 3, and after being received by the receiving unit 31 of the second processing means 3 provided outside of the rotating unit, the output signal is separated for every receiving sensor portion in the signal processing unit 33, that is, after being corrected for every receiving sensor portion in a state in which the detection independency for every receiving sensor portion and the non interference property between different receiving sensor portions are maintained, the output signal is coordinate-converted into the six component forces for every angle rotation.

Consequently, the correction for different deformations for each and every receiving sensor portion is easily performed, and the high accuracy of the six component forces is realized. Moreover, since the bridge circuit is constituted for every receiving sensor portion, the wiring needs not to be lengthy, and the signal error accompanied with the wiring is reduced.

As the number of receiving sensor portions increases, so the number of separated output signals increases, and therefore, the independency and the non-interference property between the output signals increase, and the high accuracy of the six component forces and the high accuracy of the correction of the output signal are realized, so that the number of sensing beams or receiving sensor portions and output signals are not necessarily required to be eight.

Moreover, in the present embodiment, since the arm 14 having the character I shaped sectional unit 15b is adopted, comparing to the arm having a quadrangular section, the effect of the strain component by the side force Fs applied on the sensitive surface can be reduced, and a highly accurate output signal can be obtained from the strain gauge.

Next, the rotary type component force measuring device with the number of sensing beams taken as five which represents a constitutional degree of freedom is shown below as an example capable of performing the correction for each and every receiving sensor portion by data-transferring the signal for each and every receiving sensor portion to the signal processing unit as it is, and finding the component force value by the data correction by using a high speed calculating function in the signal processing unit and by the coordinate conversion accompanied with the receiving sensor constitution, and further as an example capable of providing a rotary type component force measuring method and a rotary type component force measuring device only by the change of the number of data transmission signals corresponding to the quantity, constitution, and arrangement of receiving sensor portions and the change of the calculating method of the signal processing unit.

For example, though the embodiment of the rotary type component force detector 11 of FIGS. 1 and 8 is constituted to have four arm 14 and eight sensing beams 15 and 16, the present invention is realized not by taking out the six component forces from the inside of the rotating unit to the outside of the rotating unit, but by forming the bridge circuit for each and every receiving sensor portion and taking out the output signal for each and every receiving sensor portion, and performing the correction by the deformation of each receiving sensor portion accompanied with the rotation for each and every receiving sensor portion.

That is, the present invention has features capable of easily changing the number of the arms 14 or receiving the beams 15 and 16, and is not necessarily constituted by four arms 14 and eight sensing beams 15 and 16. Consequently, even when the number of arms 14 is changed to, for example, three or five to nine, the method of forming the bridge circuit for every receiving sensor portion and taking out the output signal as it is of the present invention can be easily realized only by increasing the number of output signals. Further, the number of receiving sensor portions can be easily changed with a view to apply the correction from the outside of the rotating unit. Further, it is apparent that the change of the number of output signals and the number of transmission data as well as the correction outside of the rotating unit accompanied with the above described changes, and the coordinate conversion can be also easily performed.

Further, when it comes to easiness of the change of the number of receiving sensor portions, though the second sensing beam 15 of the present embodiment is cross-shaped, since the number of arms 14 is not necessary four, the arm shape is not necessary required to be cross-shaped, and for example, it may be Y-character shaped or a shape laid over and combined with Y and X characters.

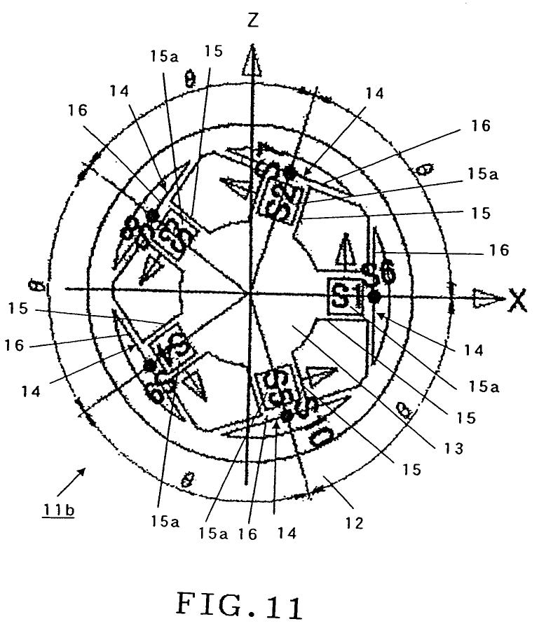

FIG. 11 is a top view of the rotary type component force detector 11b showing another embodiment of the rotary type component force detector 11.

FIG. 11 shows that the number of arms 14 is changed to, for example, five, and a bridge is formed for every receiving sensor portion of the present invention, and an output signal is taken out as it is.

In this example, the number of arms 14 is taken as five, and the angle of each arm is uniformly divided for every 2π/5, that is, for every 72 degrees, and ten of the receiving sensor portions S1 to S5 and S6 to S10 are disposed for each arm 14.

This constitution comprises: an annular rim mounting frame 12 connected to the rim of a wheel as a rotating unit; a hub mounting frame 13 having a mounting unit to the hubs disposed in five directions from the center of the rim mounting frame 12; five of the character I shaped sectional shear beam type sensing beams 15 coupling the rim mounting frame 12 and the hub mounting frame 13; and a rotary type component force detector 11b integrally formed with the sensing beams 16 which are elastic joints constituted by five metal sheets coupling the sensing beams 15 and the rim mounting frame 12, wherein two sides of ten receiving sensor portions formed in each of a total ten sensing beams 15 and 16 are adhered with orthogonal shearing type strain gauges (not shown), and the orthogonal shearing type strain gauges are taken out by the bridge circuit for each and every receiving sensor portion as each signal, and the output signal from the bridge circuit is sampled by an electronic circuit disposed inside the rotating unit according to a timing signal obtained from a rotation angle detection signal, and is digitalized by an AD converter 21a same as shown in FIG. 6, and the digitalized output signal is transmitted to a signal processing unit 33 (FIG. 6) disposed outside of the rotating unit by electromagnetic coupling and optical data transmission or by non-contact data transmission method such as a radio transmission and the like, and ten output signals thus transmitted are corrected by correction information for each rotation angle position of the rotary type component force detector 11b stored in advance in the signal processing unit 33, and is subjected to coordinate-conversion so as to calculate the six component forces of an orthogonal coordinate system.

Further, this constitution comprises a rotary type component force detector 11b integrally formed with an annular rim mounting frame 12 connected to the rim of a wheel as a rotating unit, a hub mounting frame 13 having a mounting unit to the hubs disposed in five directions from the center of the rim mounting frame 12, and a rotary type component force detector 11b integrally formed with five sensing beams 15 of a character I shaped sectional shear beam type coupling the rim mounting frame 12 and the hub mounting frame 13, wherein five sensing beams 15 have a concave portion 15a formed on two mutually opposed surfaces, and an orthogonal shearing type strain gauge is adhered on both bottoms and both side surfaces of the concave portion 15a as the receiving sensor portion, respectively, thereby forming ten receiving sensor portions, and the orthogonal shearing type strain gauge is taken out by the bridge circuit as each signal for each and every receiving sensor portion, and the output signal from the bridge circuit is sampled by an electronic circuit disposed in the inside of the rotating unit according to a timing signal obtained from a rotation angle detection signal, and is digitalized by an AD converter 21a, and the digitalized output signal is transmitted to a signal processing unit 33 disposed outside of the rotating unit by electromagnetic coupling and optical data transmission or by non-contact data transmission method such as a radio transmission and the like, and ten output signals thus transmitted are corrected by correction information for each rotation angle position of the rotary type component force detector 11b stored in advance in the signal processing unit 33, and is subjected to coordinate-conversion so as to calculate the six component forces of an orthogonal coordinate system.

In this manner, since ten output signals are simultaneously sampled for every rotation angle, similarly to the preceding embodiment, the quantization error of the rotation angle can be controlled, and at the same time, the output signals of all the rotation angles can be obtained at a high speed.

The signal processing unit 33 in this constitution finds the six component forces of the orthogonal coordinate system from a total of ten output signals received by the receiving unit 31 shown in FIG. 6, and from the six component forces of the orthogonal coordinate system (wheel coordinate system), the coordinate conversion system to find the six component forces of the actual rotational coordinate system (vehicle running coordinate system) of the measuring object including the tire and the like is executed by the following expression.

$$( \begin{matrix}fx \\ fy \\ fz \\ mx \\ my \\ mz\end{matrix} ) = ( \begin{matrix}sin ( 0 ) & sin ( θ ) & sin ( 2 θ ) & sin ( 3 θ ) & sin ( 4 θ ) & 0 & 0 & 0 & 0 & 0 \\ cos ( 0 ) & cos ( θ ) & cos ( 2 θ ) & cos ( 3 θ ) & cos ( 4 θ ) & 0 & 0 & 0 & 0 & 0 \\ 0 & 0 & 0 & 0 & 0 & 1 & 1 & 1 & 1 & 1 \\ 0 & 0 & 0 & 0 & 0 & cos ( - π ) & cos ( θ - π ) & cos ( 2 θ - π ) & cos ( 3 θ - π ) & cos ( 4 θ - π ) \\ 1 & 1 & 1 & 1 & 1 & 0 & 0 & 0 & 0 & 0 \\ 0 & 0 & 0 & 0 & 0 & sin ( 0 ) & sin ( θ ) & sin ( 2 θ ) & sin ( 3 θ ) & sin ( 4 θ )\end{matrix} ) ( \begin{matrix}S1 \\ S2 \\ S3 \\ S4 \\ S5 \\ S6 \\ S7 \\ S8 \\ S9 \\ S10\end{matrix} ) \qquad [ Expression 4 ]$$

Further, in the signal correction circuit 33b shown in FIG. 7, a method of correcting the output signal based on the correction information (correction coefficient) of each angle position of the rotary type component force detector 11b stored in advance can be performed by the same method as the preceding embodiment.

To reduce calculation errors of the component forces much further, the coefficient of the correction information may be adjusted so as to be most close to the theoretical value of each output signal or the product of the nth term of the output signal and each term may be added as a correction term, thereby performing the correction. At this time, each collection term may be put together to become correction matrices so as to perform calculation. Further, similarly to the preceding embodiment, it is needless to mention that a high order correction, which incorporates a rotation deformation depending on the rotation of the rotary type component force detector 11b, may be performed.

Further, though the number of arms 14 in this embodiment is taken as five, even when this number is changed to, for example, three or five to nine, the method of forming a bridge for every receiving sensor portion and taking out the output signal as it is of the present invention is easily realized only by decreasing or increasing the number of output signals. Further, it is apparent that the number of output signals, the number of transmission data, the correction outside of the rotating unit, and the coordinate conversion accompanied with these changes can be easily performed.

From the above, according to the rotary type component force measuring device of the present invention, the errors of the output signal and the six component forces are reduced, and correct and highly accurate component forces can be found. Further, with respect to the constitution of the receiving sensor portion, the rotary type component force measurement aligned to the number of beams used in the actual wheel such as three, five, six, seven, and the like instead of four can be performed.

The component forces of the actual rotational coordinate system obtained by the rotary type component force measuring device 1 of the present invention and the information on the rotation angle are used for various applications such as analysis of vehicle behaviors in a starting time and a stopping time of the vehicle by a brake pedal and the like, ride quality improvement analysis for minute road surface changes in traveling, collection of simulation data of virtual road surfaces and vehicle vibrations, and the like.

While the embodiments of the rotary type component force measuring device has been described as above, it is to be understood that the rotary type component force measuring device of the present invention is not limited to the device comprising all the constituent requirements described in the embodiments. To the contrary, it is intended to cover various modifications and changes. Moreover, it is needless to mention that such modifications and changes fall within the scope of the accompanying claims of the present invention.

1. A rotary type component force measuring device for measuring forces Fx, Fy, and FZ applied in x, y, and z axial directions of an orthogonal coordinate system and torques Mx, My, and Mz acting around these axes, said measuring device having a rotary type component force detector, comprising, in integrated manner:
an annular rim mounting frame connected to a rim of a wheel as a rotating unit;
a hub mounting frame having a mounting unit to the hub disposed in the center of said rim mounting frame;
at least three first sensing beams each of which is a sheet elastic joint, each of said first sensing beams linking with said rim mounting frame;
at least three second sensing beams linking with said hub mounting frame, each of said second sensing beams linking with a corresponding one of said first sensing beams,
wherein an orthogonal shearing type strain gauge adheres to each of front and back surfaces of a receiving sensor portion formed in each of said first sensing beams and each of said second sensing beams to derive an orthogonal shearing type strain for each receiving sensor portion as an output signal from one of a plurality of bridge circuit disposed so as to correspond to respective receiving sensor portions, each of the derived output signals is digitalized by an AD converter, and the digitalized output signals are transmitted to a signal processing unit disposed on the outside of said rotating unit by means of non-contact data transmission such as electromagnetic coupling, optical data transmission or radio transmission or by means of contact data transmission such as a slip-ring and the like, and
wherein said signal processing unit operates to correct each of the output signals transmitted from said bridge circuits corresponding to respective receiving sensor portions on the basis of correction information stored beforehand and to subject the correct signals to coordinate-conversion so as to calculate the six component forces of an orthogonal coordinate system.

2. A rotary type component force measuring device for measuring forces Fx, Fy, and FZ applied in x, y, and z axial directions of an orthogonal coordinate system and torques Mx, My, and Mz acting around these axes, said measuring device having a rotary type torque detector comprising, in integrated manner:
an annular rim mounting frame connected to a rim of a wheel as a rotating unit;
a hub mounting frame having a mounting unit to the hub disposed in the center of said rim mounting frame; and
at least three sensing beams linking with said rim mounting frame and said hub mounting frame,
wherein each of said sensing beams has two mutually opposed surfaces each formed with a concave portion, and with both bottoms of said concave portion taken as a first receiving sensor portion and both side surfaces thereof as a second receiving sensor portion, an orthogonal shearing type strain gauge adheres to each of the first and second sensor portions to derive an orthogonal shearing type stain for each receiving sensor portion as an output signal from one of a plurality of bridge circuits disposed so as to correspond to respective receiving sensor portions, each of the derived output signals is digitalized by an AD converter, and the digitalized output signals are transmitted to a signal processing unit disposed on the outside of said rotating unit by means of non-contact data transmission such as electromagnetic coupling, optical data transmission or radio transmission or by means of contact data transmission such as a slip-ring and the like, and
wherein said signal processing unit operates to correct each of the output signals transmitted from said bridge circuits corresponding to respective receiving sensor portions on the basis of correction information stored beforehand and to subject the corrected signals to coordinate-conversion so as to calculate the six component forces of an orthogonal coordinate system.

3. The rotary type component force measuring device according to claim 1, wherein each of the second sensing beams has a character I shaped sectional shear beam type structure.

4. The rotary type component force measuring device according to claim 2, wherein each of the sensing beams has a character I shaped sectional shear beam type structure.

5. The rotational type component force measuring device according to claim 1, wherein the output signal from said bridge circuits is sampled by an electronic circuit disposed on the inside of said rotating unit according to a timing signal obtained from a rotation angle detection signal, before the digitalization by said AD converter, and wherein said signal processing unit operates to perform the correction based on correction information for each of rotation angles in said rotary type component force detector and to calculate the six component forces of an orthogonal coordinate system for each of rotation angles.

6. The rotary type component force measuring device according to any one of claims 1 to 5, wherein said correction information is information including a primary order correction or a higher order correction incorporating a rotational deformation according to the rotation of said rotary type component force detector.

7. The rotary type component force measuring device according to any one of claims 1 to 5, wherein said signal processing unit applies known six component forces from the outside for every rotation angle of said wheel in a resting state, and has a coordinate conversion circuit for converting said output signal into said six component forces based on a conversion matrix obtained by measuring bridge signals at that time.

8. The rotary type component force measuring device according to any one of claims 1 to 5, wherein said signal processing unit has a filter for converting said six component forces into component forces of an actual rotational coordinate system including a tire.
